(19) United States
(12) Patent Application Publication
(10) Pub. No.: US 2025/0076531 A1
(43) Pub. Date: Mar. 6, 2025

(54) Multi-View Inspection Portal With Interweaved X-Ray Beams

(71) Applicant: Viken Detection Corporation, Burlington, MA (US)

(72) Inventors: James P. Ryan, Bedford, NH (US); Peter J. Rothschild, Newton, MA (US)

(21) Appl. No.: 18/827,628

(22) Filed: Sep. 6, 2024

Related U.S. Application Data
(60) Provisional application No. 63/580,870, filed on Sep. 6, 2023.

(51) Int. Cl. G01V 5/222; G01V 5/226

(52) U.S. Cl. CPC G01V 5/222; G01V 5/226

(57) ABSTRACT

A multi-view X-ray inspection portal includes: a portal structure permitting travel of a target object in a travel direction there through. First, second, and third X-ray source modules are mounted at the portal structure with offsets between them, parallel to the travel direction. The X-ray sources output first, second, and third X-ray beams, respectively, to irradiate the target. A set of scatter detectors receives X-rays that are scattered from the target object. The third X-ray source module is disposed between the first and second X-ray source modules parallel to the travel direction. The first and second X-ray beams are simultaneously active and interleaved temporally with the third X-ray beam. In the inspection portal and a corresponding method, the inspection portal may be very compact, while maintaining throughput speed and resolution.

### RELATED APPLICATIONS

The present application claims the priority of U.S. Provisional Application Ser. No. 63/580,870, filed Sep. 6, 2023. The foregoing application is hereby incorporated herein by reference in its entirety.

### TECHNICAL FIELD

The present invention relates to a multi-view X-ray inspection portal system, and more particularly to such a system that is enabled to be compact by means of interweaving different X-ray scanning beams with each other, instead of the existing interleaving alone that characterizes some existing systems.

### BACKGROUND ART

It is desirable to determine a presence of objects such as weapons, drugs, explosives, or other contraband that have been concealed, for example, in a moving vehicle, on a person, or in any other target object. This is often done in a portal while the target object is moved past one or more systems that image the contents of the target object using penetrating radiation. The determination can be made while the target object is in motion with respect to the X-ray inspection system, or, alternatively, while the inspection system is in motion with respect to the target object (e.g., vehicle, suitcase, person) to be inspected. Systems that using multiple X-ray beams to obtain different views of the same target object may be referred to as “multi-view” X-ray scanning systems, multi-view X-ray portals, and the like.

### Summary of the Embodiments

A major limitation of existing multi-view X-ray scanning systems is the increase in the separation between scan lines that results from fully interleaving two or more X-ray beams to avoid cross-talk between respective X-ray beams. Full interleaving results in both the increase in separation between scan lines and an accompanying reduced spatial resolution in X-ray images of the target object. Furthermore, in attempting to preserve resolution while still fully interleaving, existing systems suffer a disadvantage of lower throughput of target objects through the scanning system. Better solutions are needed for multi-view X-ray scanning environments that both preserve resolution and still allow high throughput.

Embodiments described in the current application introduce temporal “interweaving.” The interweaving approach described herein substantially mitigates the reduced spatial resolution of fully interleaved systems, while still retaining much of the benefit of a reduced physical length of the multi-view system along a travel direction of the target object through the system.

Temporal interweaving involves the temporal interleaving, of at least two X-ray beams that are active simultaneously (also referred to as first and second X-ray beams, or a set #1 of X-ray beams), with a third X-ray beam (or set of X-ray beams, also referred to as a second set of X-ray beams, or a set #2 of X-ray beams). The first set of X-ray beams includes the two or more X-ray beams that are active simultaneously with each other. The second set of X-rays beams, if including more than one beam, are also active simultaneously with each other. However, the first and second sets of X-ray beams are never active at the same time, but instead are temporally interleaved.

Although embodiments described herein focus mostly on scatter detection by way of example, embodiments are not limited to scatter detection. For example, transmission X-ray detectors can also be used to measure the attenuation of any one of the X-ray beams that are used in the various embodiments.

In one particular embodiment, a multi-view X-ray inspection portal includes:
a. a portal structure configured to permit a travel of a target object in a travel direction there through;
b. first, second, and third X-ray source modules mounted at the portal structure with respective offsets, between respective X-ray source modules, parallel to the travel direction, wherein the first, second, and third X-ray sources are configured to output first, second, and third X-ray beams, respectively, to irradiate the target object in a course of the travel; and
c. a set of scatter detectors disposed to receive scattered X-rays that are scattered from the target object upon a given X-ray beam irradiating the target object, the given X-ray beam selected from the first, second, and third X-ray beams,
d. wherein, the third X-ray source module is disposed between the first and second X-ray source modules parallel to the travel direction, and
e. wherein the first, second, and third X-ray source modules are configured such that the first and second X-ray beams can be simultaneously active and interleaved temporally with the third X-ray beam.

In another particular embodiment, a method of performing multi-view X-ray inspection includes:
a. permitting travel of a target object in a travel direction;
b. irradiating the target object, in a course of the travel, by first and second X-ray beams that are simultaneously active and incident at the target object at respective positions that are offset from each other parallel to the travel direction; and
c. irradiating the target object, in the course of the travel, by a third X-ray beam that is interleaved temporally with the first and second X-ray beams and incident at the target object at a respective position between the respective positions at which the first and second X-ray beams are incident.

In a further particular embodiment, a multi-view X-ray inspection system includes:
a. at least three X-ray beam-forming modules, each including an X-ray chopper wheel configured to rotate and to output a respective scanning X-ray pencil beam to irradiate a target object for X-ray inspection,
b. wherein at least one first X-ray beam-forming module is configured to have its X-ray chopper wheel rotate at a first rotational speed and define therein only a single beam aperture configured to output the respective scanning X-ray pencil beam per rotation,
c. and wherein at least one second X-ray beam-forming module is configured to have its X-ray chopper wheel rotate at a second rotational speed and to define therein two beam apertures configured to output the respective scanning X-ray pencil beam per rotation, the first rotational speed being twice the second rotational speed.

In yet further particular embodiment, a method of performing multi-view X-ray inspection includes:
a. causing at least three X-ray chopper wheels to rotate and to irradiate a target object by respective scanning X-ray pencil beams output from respective X-ray chopper wheels;
b. causing at least one first of the X-ray chopper wheels to rotate at a first rotational speed and to output its respective scanning X-ray pencil beam through only a single aperture per rotation; and
c. causing at least one second of the X-ray chopper wheels to rotate at a second rotational speed and to output its respective X-ray pencil beam through two apertures per rotation, the first rotational speed being twice the second rotational speed.

In view of the present description and drawings, it will be apparent to those skilled in the art that numerous other combinations of parameters are possible, and those described as examples are for purposes of explanation only.

### BRIEF DESCRIPTION OF THE DRAWINGS

The foregoing features of embodiments will be more readily understood by reference to the following detailed description, taken with reference to the accompanying drawings, in which:

FIG. 1 (prior art) is a perspective-view diagram illustrating an example X-ray scanning system for luggage.

FIGS. 2A-2C (prior art) illustrate three different types of existing X-ray beam-forming modules that may be used as part of embodiments to generate scanning pencil beams.

FIG. 3 is a cross-sectional diagram illustrating an example multi-view X-ray inspection portal, which may be modified to incorporate elements of the present embodiments.

FIG. 4 includes top-view and side-view diagrams of an example X-ray inspection portal, which may be modified to incorporate elements of the present embodiments.

FIG. 5 is a top-view diagram illustrating a multi-view X-ray inspection portal 500 according to an embodiment.

FIG. 6 is a timing diagram for the three-view X-ray inspection portal of FIG. 5.

FIG. 7 (prior art) is a timing diagram for a prior-art three-view temporally interleaved imaging system.

FIG. 8 illustrates positions of X-ray source modules and corresponding X-ray beams of a multi-view X-ray inspection portal corresponding to four-view embodiment.

FIG. 9 is a timing diagram for a four-view embodiment.

FIG. 10 (prior art) is a timing diagram for a prior art four-view temporally interleaved imaging system.

FIG. 11 is a timing diagram for a four-view alternative embodiment with chopper wheels having different angular speeds.

FIG. 12 illustrates crosstalk interference between two X-ray imaging subsystems in close proximity.

FIG. 13 illustrates use of detector rotation to reduce crosstalk interference in one direction between two X-ray imaging subsystems in close proximity, consistent with various embodiments.

FIG. 14 illustrates using detector rotation and detector collimator vanes to reduce crosstalk interference in one direction between two X-ray imaging subsystems in close proximity, consistent with various embodiments.

FIG. 15 illustrates a detector rotation and collimation setup for reducing crosstalk in both directions between X-ray imaging subsystems in close proximity, consistent with various embodiments.

FIG. 16 is an illustration of a preferred asymmetric detector embodiment with only three banks of backscatter detectors per imaging subsystem.

FIG. 17 is an illustration of a three-view system with detector rotation and collimation, according to an embodiment.

FIG. 18 is an illustration of a four-view system having detector rotation and collimation, consistent with an embodiment.

### DETAILED DESCRIPTION

### Certain General Considerations

The figures and descriptions provided herein may have been simplified to illustrate aspects that are relevant for a clear understanding of the herein described devices, systems, and methods, while eliminating, for the purpose of clarity, other aspects that may be found in typical similar devices, systems, and methods. Those of ordinary skill may recognize that other elements and/or operations may be desirable and/or necessary to implement the devices, systems, and methods described herein. But because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

The terminology used herein is for the purpose of describing particular example embodiments only and is not intended to be limiting. For example, as used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc., may be used herein to describe various elements, components, regions, layers and/or sections, these elements, components, regions, layers and/or sections should not be limited by these terms. These terms may be only used to distinguish one element, component, region, layer or section from another element, component, region, layer or section. That is, terms such as “first,” “second,” and other numerical terms, when used herein, do not imply a sequence or order unless clearly indicated by the context.

### Definitions

As used in this description and the accompanying claims, the following terms shall have the meanings indicated, unless the context otherwise requires:

“Set.” A “set” includes at least one member.

“Target” and “target object” refer to an object to be inspected via X-ray scanning. Example target objects include vehicles, luggage, bags, packages, containers, and people.

“About,” when used in relation to offsets or other distances denotes a tolerance of 10%.

“Substantially equal angular speed” indicates equal angular speed within +/−5% tolerance. “About” in relation to angular speed indicates a tolerance of +/−5%.

“Rotating collimator assembly” is an X-ray beam forming module including a chopper wheel. Example chopper wheels may be selected from the group consisting of rotating disk chopper wheels, rotating wheel chopper wheels, rotating hoop chopper wheels, rotating drum chopper wheels, and combinations thereof. An X-ray beam forming module that includes a “rotating disk chopper wheel” may include an X-ray fan beam that is incident on the rotating disk chopper wheel, either at a nominally perpendicular angle or a non-perpendicular angle between a plane containing the X-ray fan beam and a plane of the rotating disk chopper wheel. The non-perpendicular angle case may be referred to as a “tilted” or “angled” disk chopper wheel.

“Portal structure” includes any arrangement by which equipment may be mounted with respect to the ground. Example components of a “portal structure” may include an above-ground, overhead gantry framework structure through which target objects to be inspected (e.g., vehicles) can pass, and to which X-ray source module(s) and/or X-ray detector(s) may be mounted. Other example components of a “portal structure” may include an accommodation for mounting X-ray source module(s) and/or X-ray detector(s) underground or on a surface of a roadway. Target objects to be inspected (e.g., vehicles) may travel on the roadway and may simultaneously pass under an overhead gantry portion of a portal structure.

### Certain Characteristics and Limitations of Existing Systems

Indeed, since inspection rate, and thus hourly throughput, is at a premium, it is desirable that the vehicle, for example, be driven without requiring the driver or passengers to alight. In case a detection is made, a visual image should be available for verification.

The use of images produced by detection and analysis of penetrating radiation scattered from an irradiated object, container, or vehicle is the subject, for example, of U.S. Pat. No. 6,459,764, to Chalmers et al. (the “Chalmers patent”), issued Oct. 1, 2002, and incorporated herein by reference. The Chalmers patent teaches backscatter inspection of a moving vehicle by irradiating the vehicle with X-rays from above or beneath the moving vehicle, as well as from the side.

The use of an X-ray source and an X-ray detector, both located in a portal, for purposes of screening personnel, is the subject, for example, of U.S. Pat. No. 6,094,472, to Smith, issued Jul. 25, 2000. Since X-rays are scattered from matter in all directions, scatter may be detected by an X-ray detector disposed at any angle to the scattering material with respect to the direction of incidence of the irradiating radiation. Therefore, a “flying spot” irradiation system is typically used, whereby a single point on the target object is irradiated with penetrating radiation at any given moment, so that the locus of scatter can be determined unambiguously, at least with respect to the plane transverse to the direction of the beam of penetrating radiation.

### Spatially Offset Imaging Systems

In order to obtain multiple views of an target object, multiple backscatter imaging systems may be employed in a single inspection tunnel. This may result in interference, or cross talk, between respective imaging systems, resulting in image degradation. This is due to the lack of each flying-spot imager's ability to distinguish the origin of the scattered radiation from each imager's source. To date, this problem has been addressed by placing the imagers some distance apart [measured in a direction of movement (travel) of a target, such as a vehicle, through the inspection tunnel] to minimize cross talk. This solution is described in U.S. Pat. No. 6,151,381, to Grodzins, issued Nov. 21, 2000, wherein it is recommended that the beam planes of the imagers be placed 15 feet apart, for example (col. 3, line 59). One issue with this approach is that it causes a size of the overall system to increase. In space-limited applications, this is often undesirable.

Spatially offset imaging portal systems operating at an X-ray energy of 450 kV have been manufactured and sold, using two very large non-synchronized chopper wheels separated about 16 feet apart in the direction of vehicle travel to reduce cross talk interference.

Viken® Detection Corp. started manufacturing a 225 kV Osprey™ EVX Portal in 2021, which included left-down, right-down, and undercarriage views. The system included non-interleaved X-ray beams output from chopper wheels separated by at least 16 feet from each other, parallel to the vehicle travel direction, to reduce or eliminate cross talk.

### Techniques to Reduce Interference Between Non-Interleaved Imaging Systems

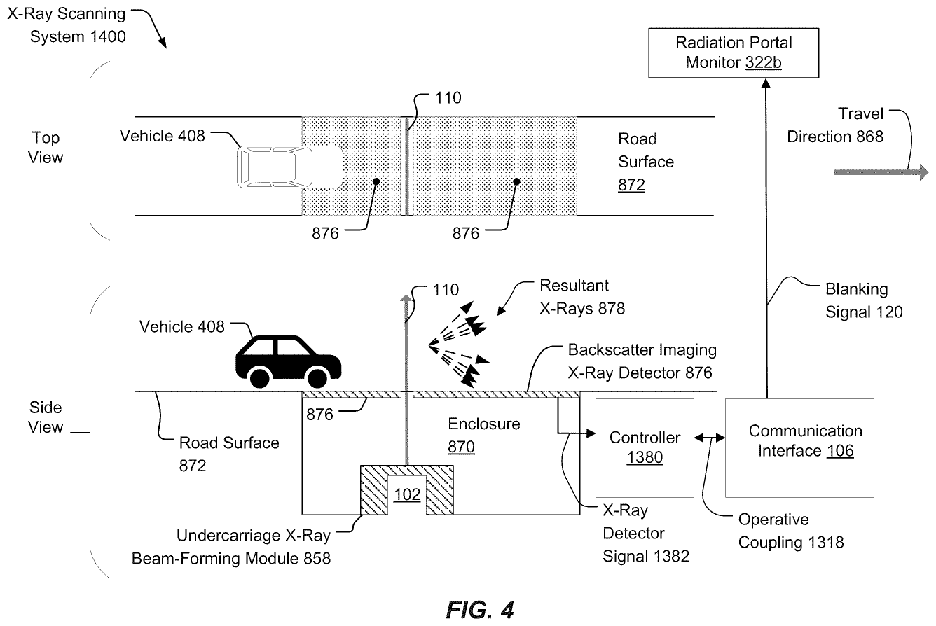

Collimation vanes have been described in some patents to reduce unwanted cross talk interference between X-ray beams that are in close proximity and that are active at the same time. For example, U.S. Pat. No. 7,995,707, to Rothschild, issued Aug. 9, 2011, describes a conveyorized X-ray bag scanner system that uses shielding vanes on a backscatter detector to shield it from scatter coming from a fan beam used to create simultaneous transmission images. Rothschild also describes an embodiment wherein the undesirable cross talk is reduced by angling the backscatter detectors so that they are optimized towards receiving only scatter from the backscatter X-ray beam, in addition to using one or more collimation vanes, as shown in FIG. 4 of the Rothschild patent.

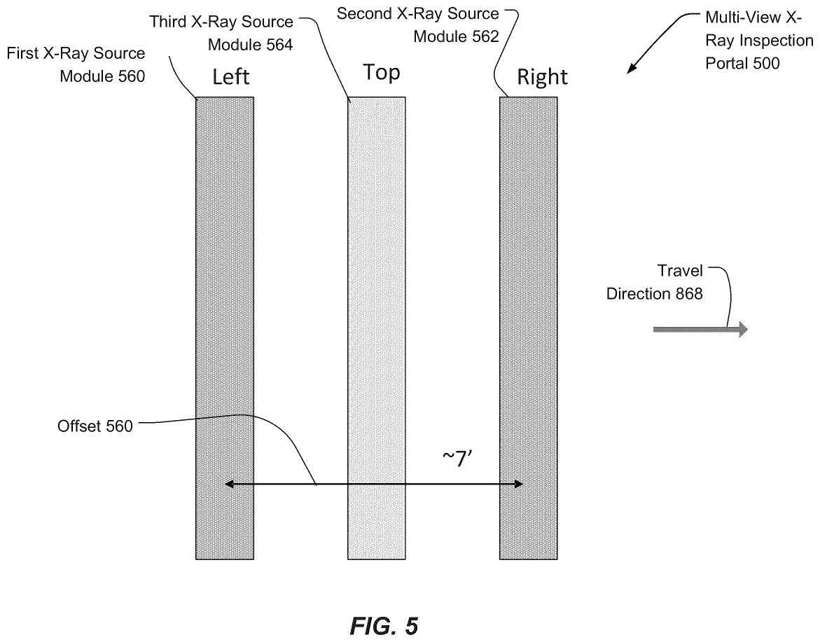

In U.S. Pat. No. 6,151,381, to Grodzins, issued Nov. 21, 2000, an embodiment is described that uses collimation vanes installed on the front of backscatter detectors to shield them from unwanted interference as shown in FIG. 5 of the Grodzins patent. Additionally, U.S. Pat. No. 8,300,763, to Shedlock, issued Oct. 30, 2012, describes an embodiment that uses multiple simultaneously active pencil beams, and collimation vanes on scatter detectors, to reduce cross talk interference (col. 4, line 53) of the Shedlock patent.

### Temporal Interleaving of Imaging Systems

The most effective approach for eliminating cross talk interference is to temporally interleave the X-ray beams, so that only one beam is ever active at any given time. For example, in U.S. Pat. No. 6,459,761 to Grodzins, issued on Oct. 1, 2002 (col. 8, line 45), cross talk between two X-ray backscatter imaging systems is eliminated completely by synchronizing the two chopper wheels producing the two sweeping pencil beams that irradiate the target object from each side as it passes through the system. Each wheel has two apertures, one wheel with the apertures at the 0 deg. and 180 deg. position, and the other wheel with the apertures positioned at 90 deg. and 270 deg. Synchronizing the rotation of the two wheels with each other ensures that only one beam is irradiating the object at any given time, eliminating cross talk artifacts completely.

This concept of temporal interleaving also forms the subject of U.S. Pat. No. 7,400,701, to Cason, issued on Jul. 15, 2008. In one described embodiment, there is provided an inspection system for inspecting an object that is characterized by motion in a particular direction with respect to the inspection system, by virtue of motion with respect to the local frame of reference of either the object, the inspection system, or both. The inspection system has a first source for providing a first beam of penetrating radiation of specified cross-section directed in a first beam direction substantially transverse to the direction of motion of the object. It also has a second source for providing a second beam of penetrating radiation in a second beam direction and may have additional sources of additional beams. The beams of penetrating radiation are temporally interspersed. Additionally, the system has a plurality of scatter detectors for detecting radiation scattered from at least one of the first beam and the other beams by any scattering material within the target object and for generating a scattered radiation signal. The system may also have one or more transmission detectors for detecting penetrating radiation transmitted through the object. Finally, the system has a controller for creating an image of the scattering material based at least on the scattered radiation signal or for otherwise characterizing the scattering material.

In accordance with alternate described embodiments of the Cason patent, the first source of penetrating radiation may be an X-ray source, as may the other sources of penetrating radiation. The first beam direction and the direction of any other beam may be substantially coplanar. The various sources may include a beam scanning mechanism, such as a rotating chopper wheel or an electromagnetic scanner, and one or more of the beams may be pencil beams. In accordance with yet further embodiments, emission of penetrating radiation in the first beam may be characterized by a first temporal period and emission of penetrating radiation in the second beam may be characterized by a second temporal period, with the first and the second temporal periods offset by a fixed phase relationship. The temporal period of each source may be characterized by a duty cycle, and the emission of adjacent sources may be characterized by a phase relationship with respect to an adjacent source, where the phase relationship may equal to 2× times the duty cycle. The inspection system may further include a display for displaying a scatter image of material disposed within the target object.

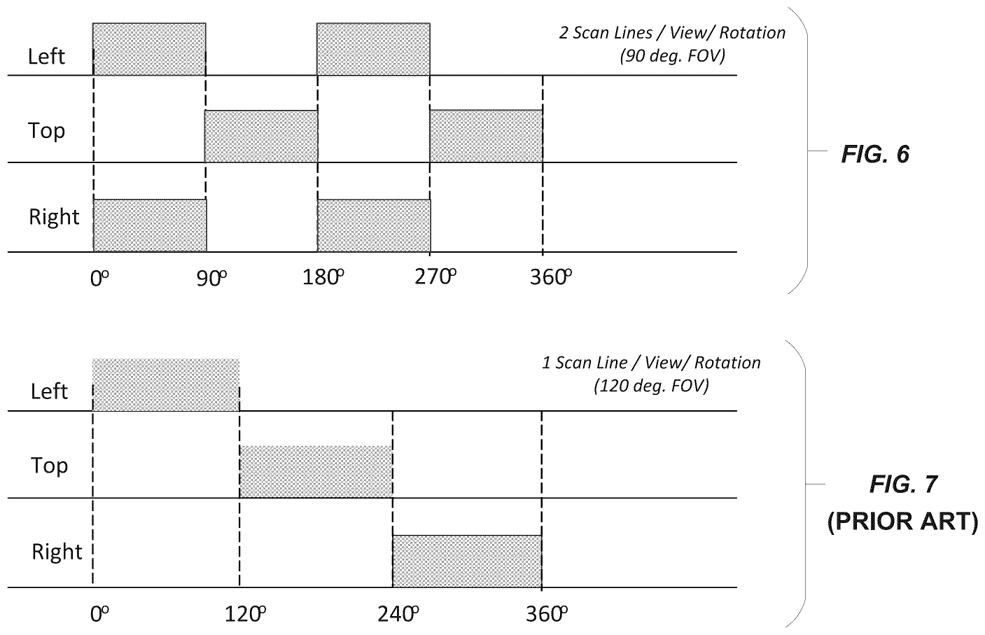

The principal advantage of temporal interleaving in a multi-view X-inspection system is that it allows the imaging subsystems to be substantially coplanar, as only one beam is irradiating the target object at any given time. This allows, for example, a compact multi-view portal such as the American Science and Engineering (AS&E) Z-Portal™ with three views (left, right, and top views) to be relatively compact along the scan direction (i.e., the direction of motion of the vehicle relative to the imaging system). The first Z-Portal™ was installed in Singapore in 2003, and a more modern version is shown in FIG. 6.

The main disadvantage of temporally interleaving the imaging subsystems is that only a fraction of each rotation of each of the mechanical chopper wheels forming the beams is used to scan the target object. For example, for a three-view multi-view system that shares the irradiation time equally between the three views, each source is only irradiating the target object for one third of the time. Typically, the 360 deg. in a full rotation of the chopper wheel is split evenly into three 120 deg. segments, allowing the beam for each of the three views to sweep through 120 deg. This large field of view, formed with one beam aperture per wheel, is optimal for imaging large vehicles, as the sources can then be moved closer to the scan tunnel while still providing full height or width coverage of the vehicle. Alternatively, two apertures per wheel could be provided, forming two 60 deg. beam sweeps per rotation per view. However, this is typically too small a sweep angle to provide adequate coverage of a vehicle, and typically, the sweep angle of the beams for vehicle inspection should be between about 80 deg. and 120 deg.

This means that for a three-view system with only one beam aperture per wheel, the number of times per second that the beam sweeps across the target object as it moves through the imaging system is reduced by a factor of three compared with a non-interleaved system. As an example, a non-interleaved chopper wheel rotating at 3,000 rpm with three beam apertures will create 150 scan lines per second. At a scan speed of 5 kph, the separation between the scan lines on the target object would therefore be approximately 1 cm, providing an image with reasonable spatial resolution. However, if the chopper wheels each have only one aperture to facilitate three-view temporal interleaving, the separation between scan lines at 5 kph will be approximately 3 cm, leading to images with much poorer spatial resolution. In order to produce images with a comparable resolution, the target object would have to be moved through the system at only one third the speed (1.7 kph), greatly reducing the number of objects that can be inspected per hour. For multi-view systems that include four views, the problem becomes even more serious, with the separation between scan lines increasing to 4 cm, and a scan speed needing to be reduced to only 1.25 kph to create images of comparable resolution. Accordingly, the vehicle throughput of such a four-view imaging system is only one quarter that of the non-interleaved four-view imaging system.

One way to decrease the separation between the scan lines and gain back some of the lost spatial resolution at a given scan speed is to simply increase the rotation speeds of the chopper wheels. However, this is often an extremely difficult engineering challenge, as a wheel speed of 9,000 rpm would be required to regain the original resolution in a 3,000 rpm three-view system, and 12,000 rpm would be required for a four-view system. The forces on the chopper wheels and bearings become extremely large, requiring expensive exotic materials and complex designs to be used. Additionally, the dwell time for each scan line as it sweeps across the target object is inversely proportional to the rotation speed, so that the signal-to-noise ratio (SNR) of the produced images decreases inversely with the square root of the wheel speed. For example, a 9,000 rpm chopper wheel for a three-view system would produce images with an SNR of only 58% of the non-interleaved images, while the SNR of the four-view system would be only 50% of the non-interleaved images.

### System Elements Helpful for Understanding of the Present Embodiments

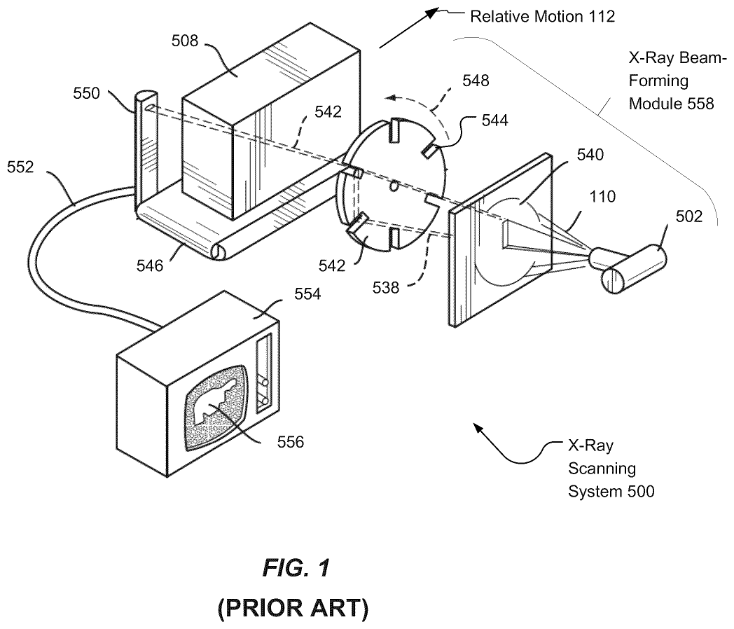

FIG. 1 (prior art) is a perspective-view diagram illustrating an example X-ray scanning system for luggage. An X-ray scanning system 500 of FIG. 1 exemplifies some basic features of known backscatter imaging systems that output a scanning pencil beam 542 of the source X-rays 110. An X-ray source 502 in this embodiment is a standard X-ray tube, which generates the source X-rays 110. The source X-rays 110 are formed (here, collimated) into a stationary fan beam 538 by a collimation slit aperture in an attenuating plate 540. The stationary fan beam 539 can then be “chopped” into a scanning pencil beam 542 by a disk chopper wheel 542 that defines scanning slit apertures 544 (which may also be referred to herein as “slits”) therein and rotates with a rotation 548. Together, the X-ray source 502, the attenuating plate 540, and the disk chopper wheel 542 form an X-ray beam-forming module 558. In alternative implementations, the source X-rays 110 are formed only into the stationary fan beam 538, which is used to scan over the target directly, without a need for the disk chopper wheel 542.

The scanning pencil beam 542 thus scans over an article of luggage 508 as the article of luggage 508 moves with the relative motion 112 (travel direction) between the article of luggage 508 and the X-ray source 508. The article of luggage 508 is an example of a target object to be inspected. The relative motion 112 in this diagram is provided by a conveyor 546, which includes a table and a conveyor belt that moves the article of luggage 508 with respect to the source 502.

The X-ray scanning system 500 can perform transmission X-ray imaging using a transmission X-ray detector 550. X-rays of the scanning pencil beam 542 that interact with the article of luggage 508 (in this case by being transmitted through the article of luggage 508) are detected by the transmission X-ray detector 550. The transmission X-ray detector 550 outputs a detector signal to a monitor 554 via a detector signal cable 552, and the monitor 554 shows a transmission X-ray image 556 of contents of the article of luggage 508.

The X-ray scanning system 500 can also perform backscatter X-ray imaging using a set of backscatter imaging X-ray detectors (not shown in FIG. 1). The backscatter imaging X-ray detectors may be positioned to detect resultant X-rays that result from the scanning pencil beam 542 interacting with the article of luggage 508 and are scattered by the article of luggage 508 in a general or specific backward direction, such as in a vicinity between the article of luggage 508 and the disk chopper wheel 542. An intensity of the resultant X-rays scattered in the backwards direction may be thus recorded by the set of more backscatter X-ray backscatter detectors (not shown in FIG. 1) as a function of position of the irradiating, scanning pencil beam 542. In the case of backscatter X-ray imaging, it can be advantageous for the backscatter X-ray detectors to be large-area detectors in order to detect the greatest number of X-rays scattered in various specific backward directions. By moving the article of luggage 508 through a scan plane of the pencil scanning beam 542, cither on the conveyor 546 or under its own power, a two-dimensional backscatter image of the article of luggage 508 may be obtained.

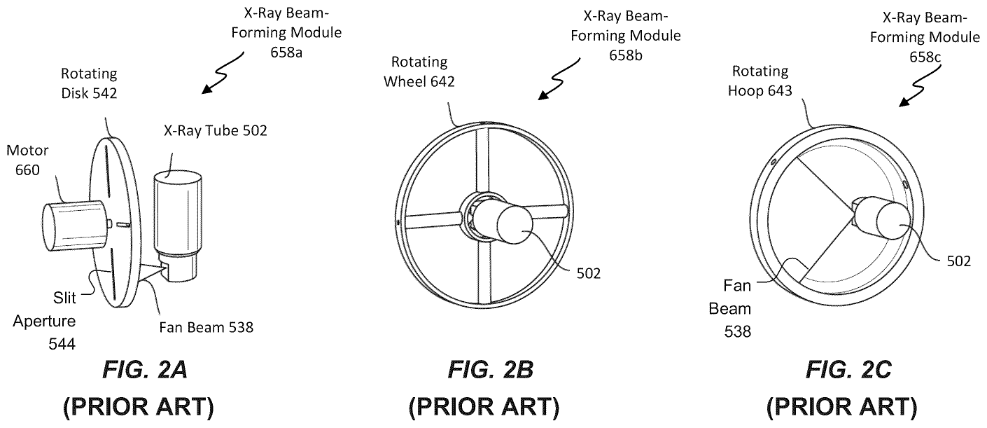

FIGS. 2A-2C (prior art) illustrate three different types of existing X-ray beam-forming modules that may be used as part of embodiments to generate scanning pencil beams. The scanning pencil beams may be generated from a substantially stationary, wide X-ray beam of source X-rays emanating either directly from the X-ray tube 502 or also through an intermediary collimation plate, which may also be referred to herein as an “attenuation plate.” Collimation plates are not shown in FIGS. 2A-2C, but the attenuation plate 540 of FIG. 1 is an example. The chopper wheel of existing X-ray backscatter imaging systems is usually one of three basic types: the rotating disk chopper wheel 542 (which may also referred to herein as a “disk” or “disk chopper wheel”), a rotating wheel chopper wheel 642 (which may also be referred to herein as a “hub-and-spoke” chopper wheel), or a rotating hoop chopper wheel 643 (which may also be referred to herein as a “hoop” chopper wheel). The three types are shown in FIGS. 2A, 2B, 2C, respectively, in X-ray beam-forming modules 658a, 658b, 658c, respectively. The chopper wheels 542, 642, and 643 can be rotatably mounted in various ways that are known in the art of X-ray scanning. FIG. 2A illustrates one way of causing a chopper wheel to rotate, wherein the disk chopper wheel 542 is coupled to a shaft of a motor 660. Slit apertures 544 defined within the disk chopper wheel 542 serve a purpose similar to that of the slit apertures 544 of FIG. 1.

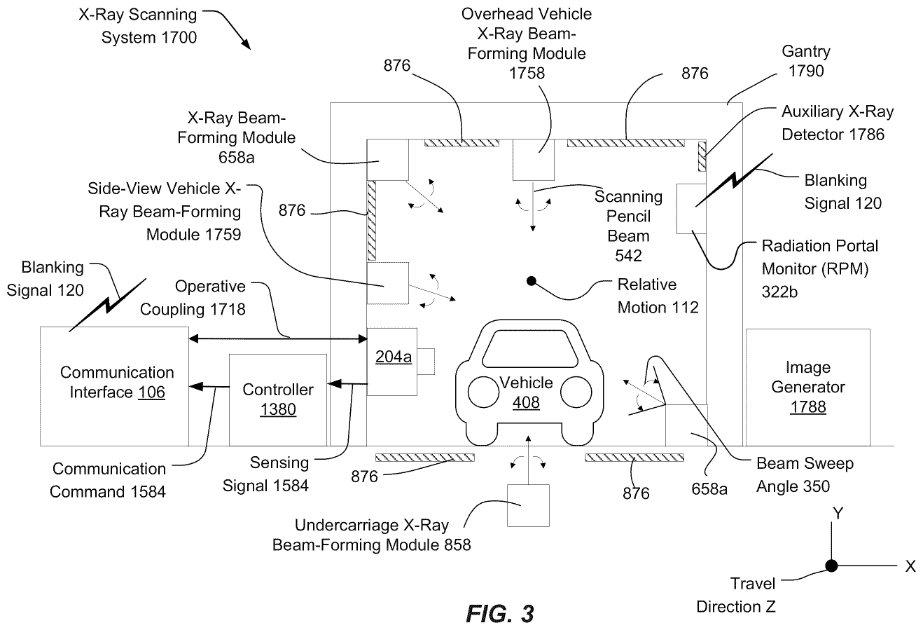

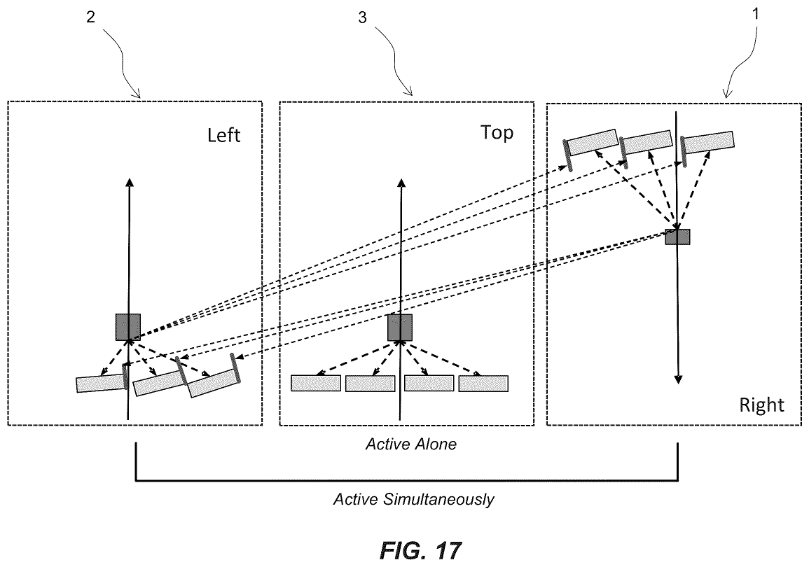

FIG. 3 is a cross-sectional diagram illustrating an X-ray scanning system 1700, in the form of a vehicle portal, which may be modified to incorporate elements of the present embodiments. The vehicle 408 passes through the X-ray vehicle scanning portal formed in part by a gantry 1790. Various X-ray beam-forming modules 658a positioned around the gantry 1790 output source X-rays in the form of scanning pencil beams 542, which are used to provide backscatter X-ray imaging of the vehicle 408. Each scanning pencil beam can have an example beam sweep angle 350. In addition, the X-ray scanning system 1700 includes the undercarriage X-ray beam-forming module 858 and an overhead vehicle X-ray beam-forming module 1758, both of which further provide scanning pencil beams 542 that can be used for X-ray backscatter imaging. A side-view vehicle X-ray beam-forming module 1759 is also included, is configured to output sources X-rays in the form of a scanning pencil beam, and may have an internal structure similar to that of the X-ray beam-forming modules 658a. Various backscatter imaging X-ray detectors 876 positioned around the gantry 1790 are used to capture resultant X-rays (not shown in FIG. 17) that result from the scanning pencil beams 542 interacting with the vehicle 408. The vehicle 408 passes through the gantry 1790 with the relative motion 112, which in this view is out of the page, perpendicular to the X and Y axes that are shown.

The X-ray scanning system 1700 further includes an image generator 1788 that receives detector signals from the backscatter imaging X-ray detectors 876 and forms X-ray backscatter images of the vehicle 408. All of the scanning pencil beams 542 can also be used for transmission X-ray imaging with appropriately placed transmission X-ray detectors, as is known in the art of X-ray imaging, similar to the transmission X-ray detector 550 and transmission X-ray imaging function depicted in FIG. 1 using the scanning pencil beam 542.

The X-ray scanning system 1700 further includes the camera system 204a, which is used to detect features of the vehicle 408 in order to determine when the vehicle 408 is about to intersect with the scanning pencil beams 542. A controller 1380 receives a sensing signal 1584 from the camera system 204a. In a specific example, the sensing signal 1584 may include raw camera images from the camera system 204a, and the controller 1380 may analyze the images in order to complete sensing of the feature(s) of the vehicle 408. In another specific example, an image analysis capability is provided in the camera system 204a, and the sensing signal 1584 is simply an ON/OFF indication of whether a particular feature of the vehicle 408 is detected.

The controller 1380, based on the sensed feature, sends a communication command 1584 to the communication interface 106, causing the communication interface 106 to output the blanking signal 120. The blanking signal 120 in this implementation is wireless and is received at the radiation portal monitor (RPM) 322b at an opposite side of the gantry 1790. Accordingly, in this implementation, the feature sensor (camera system 204a) is operatively coupled to the communication interface 106 indirectly, through the controller 1380, as indicated by an operative coupling 1718.

Also illustrated in FIG. 3 is an auxiliary X-ray detector 1786 attached to the gantry 1790 near the RPM 322b. In an alternative implementation, the camera system 204a, controller 1380, and communication interface 106 are not required. Instead, the auxiliary X-ray detector 1786 is used solely to detect X-rays scattered from features of the vehicle 408, not for X-ray imaging, and its X-ray detector signal (not shown in FIG. 3) is output to the auxiliary X-ray detector 1786. When X-ray detector signal of the auxiliary X-ray detector 1786 exceeds a given threshold value, the RPM 322b pauses accumulation of radiation detection data. In an alternative implementation, the auxiliary X-ray detector 1786 includes a communication interface and outputs a blanking signal.

In yet other specific alternative implementations, one of the detectors 876 may be used as a transmission X-ray detector, detecting X-rays that have interacted with the vehicle 408. While an output signal from the transmission X-ray detector may be used for transmission X-ray imaging, such as by providing its output signal to the image generator 1788, the output signal, or a blanking signal based on the output signal, may further be provided to the RPM 322b to pause accumulation of radiation detection data when the transmission X-ray detector signal has exceeded a threshold, similar to either of the examples described above for the auxiliary X-ray detector 1786.

FIG. 4 includes top-view and side-view diagrams of an example X-ray inspection portal, which may be modified to incorporate elements of the present embodiments. Specifically, an X-ray scanning system 1400 is in a form of a vehicle portal an includes certain elements that can be present in existing vehicle portals. However, system 1400 further includes specialized apparatus helpful to avoid interference of scatter X-rays with the RPM 322b. Signals output from the backscatter imaging X-ray detectors 876 are used to determine whether the blanking signal 120 should be output, or set to the ON state. As the backscatter imaging X-ray detectors 876 receive the resultant X-rays 878, they output an X-ray detector signal 1382 to a controller 1380. The controller 1380 receives the X-ray detector signal 1382 and determines whether a rate of detection indicated by the X-ray detector signal 1382 exceeds a given threshold.

The threshold rate of detection may be stored in a memory of the controller 1380, accessible to a processor of the controller 1380, for example. The controller 1380 is operatively coupled to the communication interface 106 and causes the communication interface 106 to output the blanking signal 120, or to set the blanking signal 122 the ON state, responsive to the rate of detection exceeding the threshold. The blanking signal 120 is received at the RPM 322b, and, when set to the ON state, results in the RPM 322b pausing accumulation of radiation detector data. The controller 1380 may be an analog comparator circuit configured to compare X-ray detector signal 1382 with a reference signal. Alternatively or additionally, the controller 1380 may include an analog-to-digital (A/D) converter that converts the X-ray detector signal 1382 to a digital signal, and a processor that digitally compares the digital signal to a the predetermined threshold value. The controller may be integrated with the X-ray detector 1376, may be a separate, dedicated controller (e.g., a computer or analog or digital signal processor), or a controller that performs other functions related to the X-ray scanning of the X-ray scanning system 1400 and additionally performs the signal comparison function.

### Interweaving in Certain of the Present Embodiments

Embodiments described in the current application introduce temporal “interweaving.” The interweaving approach described herein substantially mitigates reduced spatial resolution of fully interleaved, multi-view X-ray inspection systems, while still retaining much of the benefit of a reduced physical length of the multi-view system along a travel direction of the target object through the system.

Temporal interweaving involves, in part, temporal interleaving. A set of at least two X-ray beams that are active simultaneously (also referred to as first and second X-ray beams, or a set #1 of X-ray beams), is interleaved with a third X-ray beam (or set of X-ray beams, also referred to as a second set of X-ray beams, or a set #2 of X-ray beams). The first set of X-ray beams includes the two or more X-ray beams that are active simultaneously with each other. The second set of X-rays beams, if including more than one beam, are also active simultaneously with each other. However, the first and second sets of X-ray beams are never active at the same time, but instead are temporally interleaved.

### Example Three-View Embodiments

FIG. 5 is a top-view diagram illustrating a multi-view X-ray inspection portal 500 according to an embodiment. Positions of first, second, and third X-ray source modules 560, 562, and 564, respectively, are shown. These modules are also considered to mark respective positions of X-ray beams output from the respective modules, with offsets between each other parallel to a travel direction 868 of a target object (e.g., vehicle) through the portal 500. In this example, for simplicity, the beam positions are nominally perpendicular to the travel direction 868. An example offset 560 between the first and second X-ray source modules is shown, and while not shown, there are similar offsets, measured in similar fashion, between center positions of each pair of modules 560, 562, 564.

X-ray beams are offset from each other parallel to a travel direction Z of a vehicle through the multi-view X-ray inspection portal, consistent with a first example embodiment. The three X-rays source modules and corresponding beams are exaggerated in size only for convenience of illustration. The first embodiment is applicable to a multi-view inspection portal with three views, as indicated by the three X-ray beams shown in FIG. 5. Rather than using full temporal interleaving of the three beams such that only one beam is active at any given time, two of the sources are synchronized such that they simultaneously irradiate the target object, with the third source irradiating the object only when the other two sources are inactive. This is termed “interweaving,” with the synchronous pair of sources alternating or “interweaved” temporally with the third source.

In FIG. 5, crosstalk interference between the two sources that are active simultaneously may be reduced through a combination of increasing the separation or “spatial offset” between the two synchronous sources (as used in the spatially offset, non-interleaved systems described previously) and additionally by rotating (and optionally collimating) the scatter detectors so that they are less susceptible to crosstalk interference. In particular, the scatter detectors may be rotated such that they cannot see direct scatter resulting from the other interfering synchronous source, but rather only direct scatter from the actual primary imaging beam. In addition, small shielding vanes optionally can be mounted on each scatter detector so that a smaller rotation angle can be used for a given separation of the synchronous sources to prevent detection of the direct scatter from the interfering beam. The small shielding vanes can advantageously allow the scatter detectors to be positioned closer to the target object to be inspected, thus increasing a solid angle of detection, without interfering physically with the target object as it moves through the system.

In FIG. 5, the left and right imaging systems irradiate the target object simultaneously, and the middle source for the top view is interweaved with the other two synchronous sources, such that the middle source irradiates the target object only when the two synchronous side sources are not irradiating the object. This allows the separation distance (offset) between the middle source and the two side sources to be much less than 16 feet, as there is no interference between the middle and side sources. The left and right synchronous sources, however, are preferably substantially separated from each other to prevent cross talk interference. In one example, a separation of 15-16 feet may be required. However, by combining in a common X-ray scanning system the interweaved sources and rotation of the backscatter detectors as described in detail hereinafter, the separation between the left and right sources can be reduced to as little as 7 feet.

While specific portal structure is not illustrated in FIG. 5, such example structure may include the gantry 1790 of FIG. 3, the enclosure 870 of FIG. 4, and similar structures that perform a function of allowing X-ray source modules, and optionally scatter or transmission detectors, to be mounted therein or thereto.

FIG. 6 is a timing diagram for a three-view X-ray inspection portal 500 of FIG. 5. FIG. 6 illustrates a significant advantage of the present embodiments. Namely, beam interweaving allows two beam apertures per X-ray source module, or per chopper wheel thereof, to be used per rotation of the chopper wheel, while still providing beam sweep angles that are large enough to provide full coverage of the target object (e.g., vehicle) being inspected. A timing diagram is shown in FIG. 6 for a three-view interweaved system, with two beam apertures in each source chopper wheel. Each horizontal line represents the rotational position of the left, right, and top source chopper wheels providing the X-ray beams of FIG. 5. For the particular system operation illustrated by the figure, the left and right X-ray sources are synchronized together, with the shaded regions above the horizontal lines indicating the periods (during one full rotation of the source wheels) when a beam aperture for that X-ray source is irradiating the target object. The middle source is interweaved temporally with the synchronized left and right sources. For the particular example shown, the beam sweep angle of each view is 90 deg. However, other options can be chosen. For example, the left and right synchronized sources can have a sweep angle of 110 deg., and the top source can have a sweep angle of 70 deg., with the beam sweep periods still adding to 360 deg. per rotation. This is more efficient for providing full coverage of most vehicles, as vehicles are typically much taller than their width.

FIG. 7 (prior art) is a timing diagram for an existing three-view system without interweaving. Comparing the timing diagrams for the two three-view imaging systems, the interweaved source solution (FIG. 6), with synchronized left and right sources and two beam apertures per wheel, can acquire two scan lines per wheel rotation for each of the three views. This compares with only one scan line per wheel rotation for each view in the prior-art temporally interleaved system illustrated by FIG. 7, which has only one beam aperture per chopper wheel. Thus, while the interweaved system may be somewhat physically longer than the temporally interleaved system along the scan direction, it is still relatively compact and has twice the throughput for the same imaging resolution and chopper wheel rotation speed. This provides a very useful advantage when there is a requirement for high-quality imaging while retaining high throughput speeds, such as when the imaging systems are used for drug interdiction inspections of vehicles at border crossings.

### Four-View Embodiments

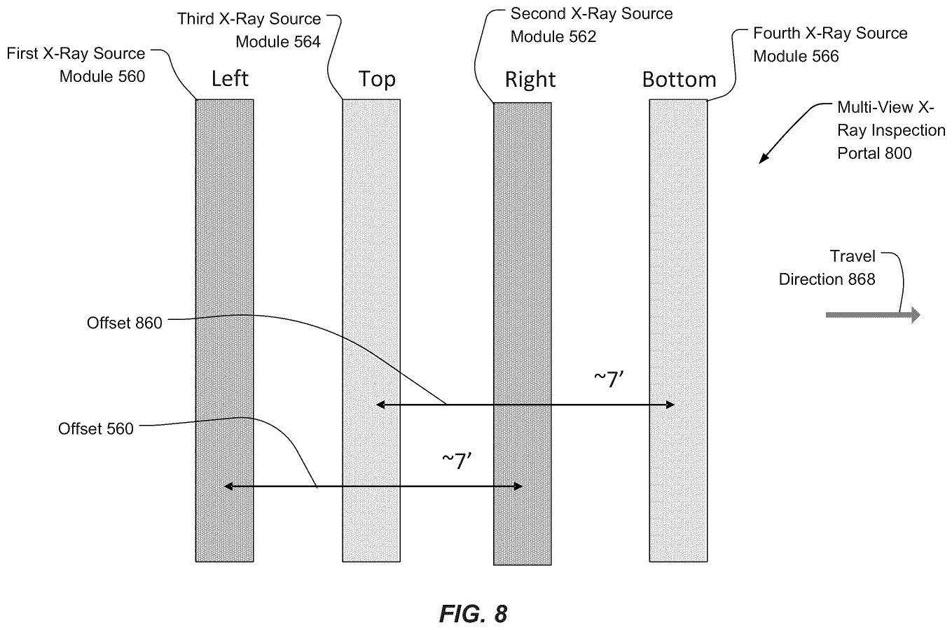

FIG. 8 illustrates positions of X-ray source modules and corresponding X-ray beams of a multi-view X-ray inspection portal corresponding to four-view embodiment. In this example, an additional fourth (bottom) view has been added to the imaging system. The fourth X-ray source module can be similar to the undercarriage X-ray beam-forming module 858 of FIGS. 3-4, for example. In the particular system illustrated by FIG. 8, the left and right side sources are synchronized and irradiate the target object simultaneously, and the top and bottom sources are synchronized together and irradiate the target object simultaneously.

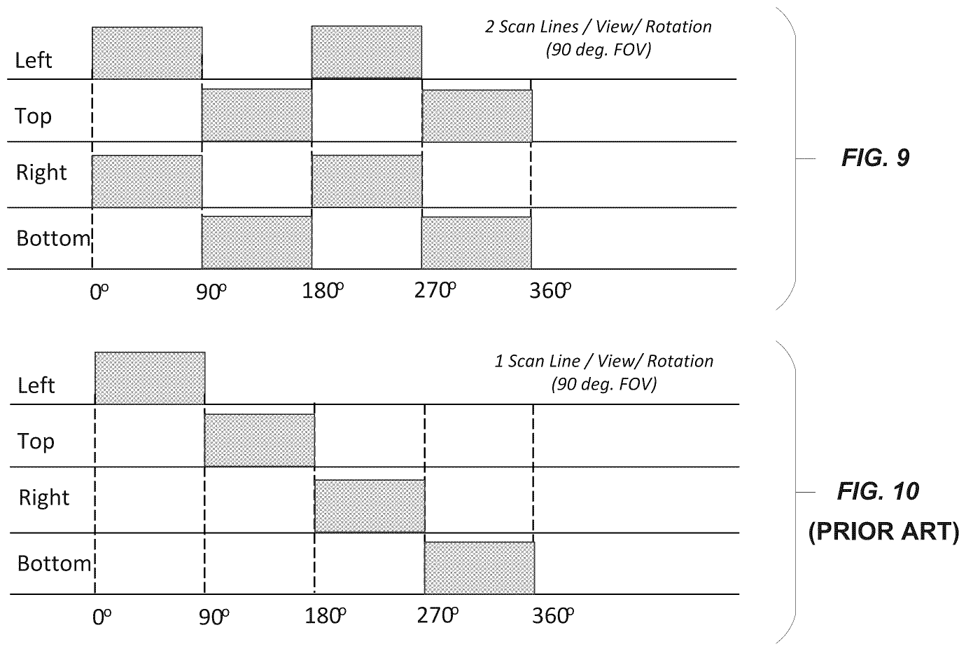

FIG. 9 is a timing diagram corresponding to the four-view embodiment of FIG. 8.

FIG. 10 (prior art) is a timing diagram for an existing four-view X-ray inspection portal having full interleaving and lacking interweaving, for comparison with FIG. 9.

With two beam apertures per X-ray chopper wheel, the timing of FIG. 9 results from the interweaved system illustrated in FIG. 8. For these two four-view systems, each system provides the same beam sweep angle of 90 deg. for each view, but the interweaved case of FIGS. 8-9 according to the embodiment provides twice as many image lines per X-ray chopper wheel rotation as the prior art case of FIG. 10. In this manner, the interweaved arrangement operation illustrated by FIGS. 8-9 results in twice the vehicle throughput as FIG. 10 for a given image resolution and chopper wheel speed.

### Alternative Embodiments

As described previously and shown in connection with FIGS. 6, 7, 9, and 10, the beam sweep angle of each source is determined by the number of views in the imaging system, and the number of beam apertures irradiated, per rotation of the mechanical X-ray chopper wheel assembly forming the scanning X-ray pencil beams. In all of the examples described so far, it is assumed that the rotational speeds of the chopper wheel assemblies for all the X-ray sources in the imaging system are equal. However, by varying the speeds of rotation of the chopper wheel assemblies, the beam sweep angle of each view can be adjusted. This can allow interweaved systems according to embodiments to be designed with a larger field of view, if required, in select views.

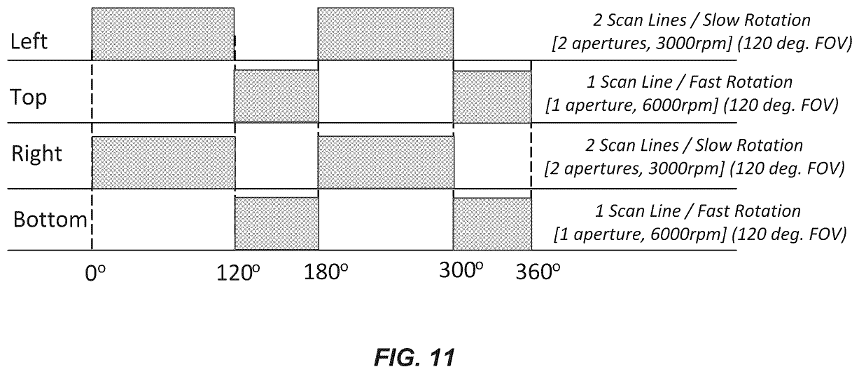

Referring to FIG. 11, a timing diagram of a four-view X-ray inspection portal with chopper wheels having different speeds is shown. In this case, as the rotating collimators (chopper wheels) of the top and bottom view X-ray sources running at twice the rotational speed of the left and right side sources. In this example, the left and right side source modules have beam-forming collimators (chopper wheels) rotating at 3,000 rpm, each with two beam apertures irradiated per rotation, and the top and bottom views have collimators rotating at twice the speed (6,000 rpm), each with only one beam aperture irradiated per rotation. This allows a four-view interweaved compact portal to be designed that has a much larger side view field of view (110 deg.) compared with the four-view portal shown in FIG. 9, which has only a 90 deg. degree side view field of view.

### Description of Certain Other Embodiments

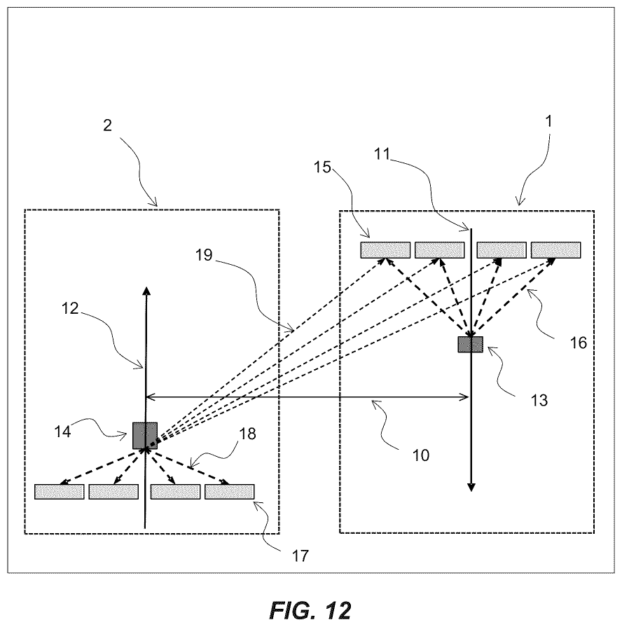

Referring to FIG. 12, a first backscatter X-ray imaging subsystem 1 is positioned close to a second backscatter X-ray imaging subsystem 2, with sweeping X-ray beams 11 and 12, respectively. As understood by those skilled in the art, sweeping pencil beams of X-rays (or “flying spot X-ray beams”) are used to create backscatter, and more generally, scatter images, by sequentially irradiating all points of an target object as the beam is raster scanned over the object as it is translated through the system. The scanning pencil beams are typically created with a rotating collimator made of highly X-ray attenuating material, such as tungsten or lead. The rotating collimator may be a disk containing one or more slit apertures, or a hoop or wheel containing one or more beam apertures located at the rim, or even a rotating drum with one or more helical slits

The beam planes of the two subsystems in FIG. 12 are separated by the distance denoted by arrow 10. The beam 11 of imaging subsystem 1 irradiates first target object 13 as it moves through beam 11, creating backscatter signal X-rays 16 that are detected in one or more backscatter detectors 15. A second target object 14 is simultaneously irradiated by the X-ray beam 12 of subsystem 2, creating backscatter signal X-rays 18 that are detected by one or more backscatter detectors 17. Additionally, undesirable interference X-rays 19 (called “crosstalk interference”) are scattered from object 14 and if the beam plane separation distance 10 is less than about 15 feet, the crosstalk X-rays 19 are detected by the backscatter detectors 15 of imaging subsystem 1. Since imaging subsystem 1 is unable to distinguish between the backscatter signal X-rays 16 used to create a backscatter image of target object 13 and the crosstalk interference X-rays 19, the scatter signals are superimposed on each other. This will create an undesirable scatter artifact from the target object 14 being irradiated in the second imaging subsystem, superimposed on the image of target object 13 being irradiated in the first imaging subsystem.

As previously described, the undesirable crosstalk interference can be reduced by increasing the beam plane separation distance 10 to at least 15 feet, which in many cases results in a portal length which is longer than allowed by the installation site. Alternatively, full temporal interleaving can be utilized, resulting in a compact portal, but poorer image quality and/or lower throughput.

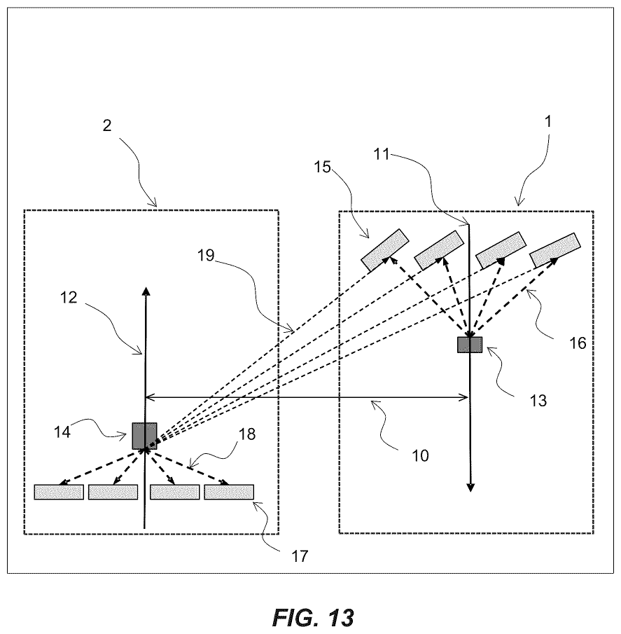

A preferred embodiment shown in FIG. 13 has two interweaved imaging subsystems 1 and 2 irradiating their respective target objects 13 and 14 simultaneously. In order to decrease the total length of the multi-view inspection portal, it is desirable to have the beam plane separation distance 10 be substantially less than 15 feet, and preferably less than approximately 10 feet. This means, however, that the interference crosstalk X-rays 19 will have sufficient intensity to create crosstalk artifacts of the object in imaging subsystem 2 that will be superimposed on the backscatter image of target object 13 in imaging subsystem 1. To compensate for the smaller beam plane separation distance 10, the backscatter detectors 15 of imaging subsystem 1 can be rotated such that the interference crosstalk X-rays 19 are substantially parallel to the front face of the detectors. This means that the sensitivity of backscatter detectors 15 of imaging subsystem 1 to crosstalk interference 19 is minimized.

A first disadvantage of the detector rotation is that if the detectors are not moved back from the target, toward the X-ray source, the front of the detectors will protrude further into the inspection area. For a vehicle inspection portal, this reduces the useable width of the scan tunnel, as the detectors can then physically interfere with the passage of the vehicle through the imaging system. However, if the backscatter detectors 15 are moved further back away from the target object 13, their ability to detect as many backscatter signal X-rays 16 is decreased.

A second disadvantage of the detector rotation is that it also decreases the ability of the backscatter detectors 15 to detect the desirable backscatter signal X-rays 16, reducing the Signal to Noise Ratio (SNR) of the backscatter images created by imaging subsystem 1. It is therefore desirable to keep the rotation angles as small as allowable.

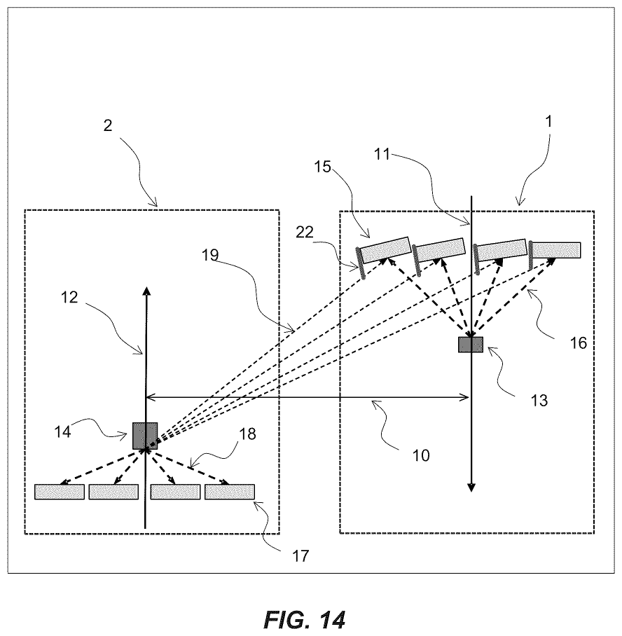

To reduce the amount of rotation needed to eliminate or reduce the crosstalk interference, one or more collimation vanes 22 can be advantageously mounted on each backscatter detector 15, as shown in FIG. 14, where there is only a single vane per detector. The collimation vanes 22 can be constructed, for example, out of thin steel or lead, but numerous other shielding materials can be used. The longer the length of vanes 22, the smaller the required rotation angle of the detectors. It has been found that for detectors with an example width of 22 inches, collimation vanes that protrude approximately 6 inches from the front face of the detectors are optimal for a beam plane separation distance 10 (offset) of 7 feet.

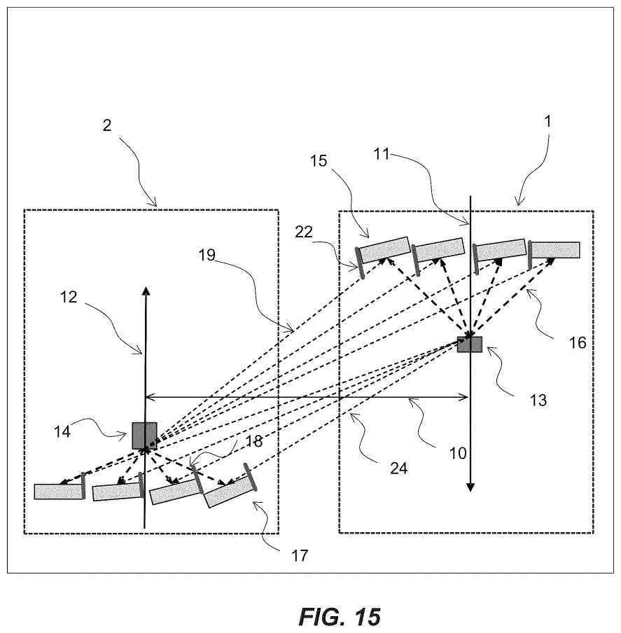

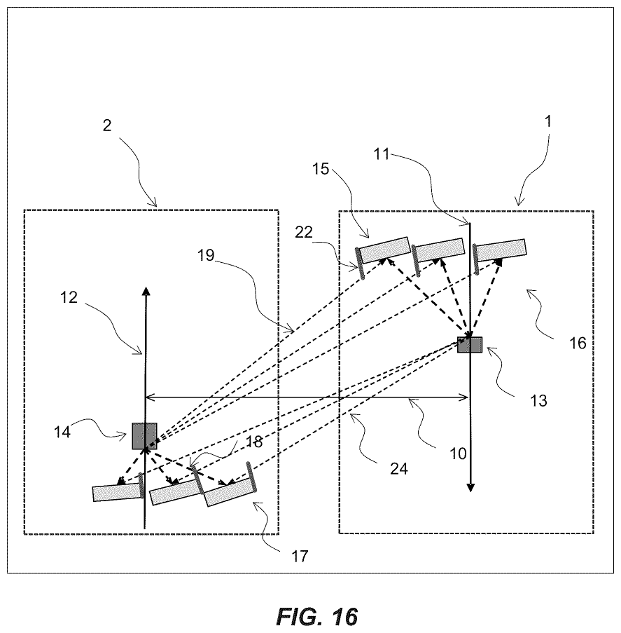

The detector rotation setup shown in FIGS. 14 and 15 are only effective at eliminating or reducing crosstalk interference from imaging subsystem 2 into the backscatter detectors 15 of imaging subsystem 1. The backscatter detectors 17 of imaging subsystem 2 will also detect crosstalk interference 24 originating from imaging subsystem 1. Referring to FIG. 15, by rotating backscatter detectors 17 and optionally mounting collimation vanes analogously to backscatter detectors 15, crosstalk interference can be reduced or eliminated in both directions.

Computer simulations have shown that there are optimal detector configurations that maximize backscatter image quality while minimizing crosstalk interference for imaging subsystems placed in close proximity to one another. These optimal configurations involve the number and positions of the detectors, detector rotation, and design of collimation vanes. For example, FIG. 16 shows a preferred embodiment for a beam plane separation of approximately 7 feet, where the backscatter detectors are no longer symmetric relative to the X-ray beams. In this embodiment, there are two banks of detectors on the side of the beam closest to the interfering subsystem, and only one bank of detectors on the side of the beam furthest from the interfering subsystem.

A preferred embodiment of a compact three-view interweaved X-ray imaging portal for vehicles is shown in FIG. 17. The multi-view portal includes two side views with left and right-oriented sweeping beams, a top view with a downward-oriented sweeping beam, and a bottom view that inspects the undercarriage of the vehicle with an upward-oriented sweeping beam. The left and right side view sources are active simultaneously, and are temporally interweaved with the top view source, which is active on its own. There is therefore no crosstalk interference in the top view image. Moreover, because it is desirable for a compact portal to have the beam planes of the simultaneously active left and right view sources to be less than 15 feet, crosstalk artifacts between the left and right views are reduced or eliminated through detector rotation and optional detector collimation. As shown in the configuration of FIG. 17, the top view backscatter detectors do not need to be rotated, because no source other than the top source is active when the top view images are being acquired. In this compact three-view configuration, it is possible to get the separation distance between the beam planes of the left and right view sources to be as small as 7 feet.

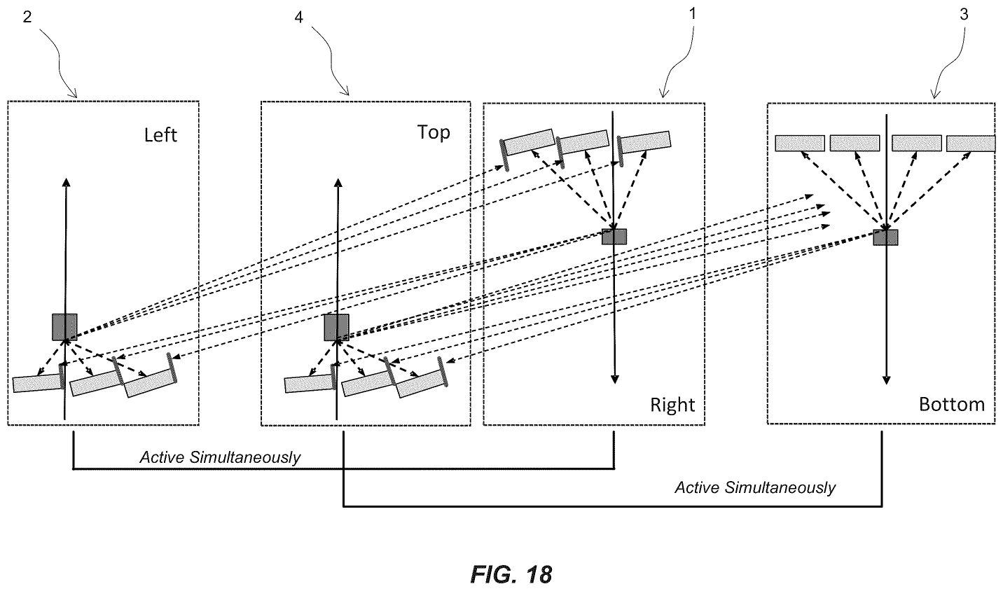

A preferred embodiment of a compact four-view interweaved X-ray imaging portal for vehicles is shown in FIG. 18. The multi-view portal includes two side views with left and right-oriented sweeping beams, a top view with a downward-oriented sweeping beam, and a bottom view that inspects the undercarriage of the vehicle with an upward-oriented sweeping beam. The left and right side view sources are active simultaneously, and are temporally interweaved with the top view source, which is active simultaneously with the bottom view. Because it is desirable for a compact portal to have the beam planes of the simultaneously active left and right view sources to be less than 15 feet, crosstalk artifacts between the left and right views are reduced or eliminated through detector rotation and/or detector collimation. Similarly, crosstalk artifacts between the top and bottom views are also reduced or eliminated through detector rotation and/or detector collimation. In the configuration shown in FIG. 18, the backscatter detectors of the bottom view are not rotated, because typically the undercarriage view is insensitive to crosstalk interference from the top view, due to the natural shielding provided by the vehicle passing over the detectors. This allows the solid angle of the bottom view detectors to be increased, providing image quality advantages compared with rotated detectors. In this compact four-view configuration, it is possible to get the separation distance between the beam planes of the left and bottom view sources to be as small as approximately 11 feet.

### Implementation Clauses

Implementation examples are provided in the following numbered clauses. The numbered clauses represent some embodiments of the present invention and potential claims. (The actual claims are provided at the end of this application.) These clauses form a part of the written description of this application. Accordingly, subject matter of the following clauses may be presented as claims in later proceedings involving this application or any application claiming priority based on this application. Inclusion of such clauses should not be construed to mean that the claims do not cover the subject matter of the clauses. Thus, a decision to not present these clauses as claims in later proceedings should not be construed as a donation of the subject matter to the public. Elements of the clauses, and their scope, will be readily understood by those of skill in the art by reference to the complete specification and drawings.

Without limitation, potential subject matter that may be claimed includes:

Clause 1. A multi-view X-ray inspection portal, comprising:
a. a portal structure configured to permit a travel of a target object in a travel direction there through;
b. first, second, and third X-ray source modules mounted at the portal structure with respective offsets, between respective X-ray source modules, parallel to the travel direction, wherein the first, second, and third X-ray sources are configured to output first, second, and third X-ray beams, respectively, to irradiate the target object in a course of the travel; and
c. a set of scatter detectors disposed to receive scattered X-rays that are scattered from the target object upon a given X-ray beam irradiating the target object, the given X-ray beam selected from the first, second, and third X-ray beams,
d. wherein, the third X-ray source module is disposed between the first and second X-ray source modules parallel to the travel direction, and
e. wherein the first, second, and third X-ray source modules are configured such that the first and second X-ray beams can be simultaneously active and interleaved temporally with the third X-ray beam.

Clause 2. The multi-view X-ray inspection portal of clause 1, wherein a set of the X-ray beams selected from the group consisting of the first, second, and third X-ray beams and combinations thereof are fan beams.

Clause 3. The multi-view X-ray inspection portal of clause 1 or clause 2, wherein a set of the X-ray beams selected from the group consisting of the first, second, and third X-ray beams and combinations thereof are scanning pencil beams.

Clause 4. The multi-view X-ray inspection portal of clause 3, wherein a set of the X-ray source modules are X-ray beam forming modules including chopper wheels selected from the group consisting of rotating disk chopper wheels, rotating wheel chopper wheels, rotating hoop chopper wheels, rotating drum chopper wheels, and combinations thereof.

Clause 5. The multi-view X-ray inspection portal of clause 4, in which the X-ray beam-forming modules are configured to have respective beam sweep angles that are equal to each other.

Clause 6. The multi-view X-ray inspection portal of clause 4, in which the X-ray beam-forming modules are configured to have respective beam sweep angles that are unequal to each other.

Clause 7. The multi-view X-ray inspection portal of clause 4, in which all of the chopper wheels are configured to rotate at substantially equal angular speed.

Clause 8. The multi-view X-ray inspection portal of clause 4, in which a first set of the chopper wheels is configured to rotate at about twice the angular speed of a second set of the chopper wheels.

Clause 9. The multi-view X-ray inspection portal of clause 8, in which the second set of chopper wheels define therein two beam apertures that output scanning pencil beams per rotation, and wherein the first set of chopper wheels define therein only one beam aperture that outputs a scanning pencil beam per rotation.

Clause 10. The multi-view X-ray inspection portal of clause 4, in which the chopper wheels create at least two scanning pencil beams per rotation.

Clause 11. The multi-view X-ray inspection portal of any of clauses 1-10,
a. wherein the set of scatter detectors is a first set of scatter detectors,
b. the multi-view X-ray inspection portal further comprising second and third sets of scatter detectors,
c. the first, second, and third sets of scatter detectors disposed to receive scattered X-rays that are scattered from the target objection upon the first, second, and third scanning pencil beams of X-rays, respectively, irradiating the target object.

Clause 12. The multi-view X-ray inspection portal of any of clauses 1-11,
a. further including a fourth X-ray source module mounted at the portal structure and configured to output a fourth X-ray beam to irradiate the target object in the course of the travel,
b. the second X-ray source module disposed between the third and fourth X-ray source module parallel to the travel direction, and
c. wherein the first, second, third, and fourth X-ray source modules are configured such that the third and fourth X-ray beams can be simultaneously active and interleaved temporally with the first and second X-ray beams.

Clause 13. The multi-view X-ray inspection portal of any of clauses 1-12, further including an image generator configured to generate, from output signals of at least one of the first, second, and third sets of scatter detectors, at least one X-ray scatter image for display.

Clause 14. The multi-view X-ray inspection portal of any of clauses 1-13, further including collimator vanes mounted on the set of scatter detectors.

Clause 15. The multi-view X-ray inspection portal of any of clauses 1-14, in which the scatter detectors are rotated to reduce crosstalk interference between the simultaneously active X-ray beams.

Clause 16. The multi-view X-ray inspection portal of any of clauses 1-15, wherein a given offset between first and second X-ray beams parallel to the travel direction is less than or equal to about 15 feet.

Clause 17. The multi-view X-ray inspection portal of clause 16, wherein the given offset is less than or equal to about 10 feet.

Clause 18. The multi-view X-ray inspection portal of clause 16, wherein the given offset is between about 15 feet and about 7 feet.

Clause 19. The multi-view X-ray inspection portal of clause 16, wherein the given offset is between about 10 feet and about 7 feet.

Clause 20. The multi-view X-ray inspection portal of clause 16, wherein the given offset is between about 15 feet and about 5 feet.

Clause 21. The multi-view X-ray inspection portal of clause 16, wherein the given offset is between about 10 feet and about 5 feet.

Clause 22. The multi-view X-ray inspection portal of clause 16, wherein the given offset is between about 20 feet and about 15 feet.

Clause 23. The multi-view X-ray inspection portal of clause 16, wherein the given offset is between about 9 feet and about 5 feet.

Clause 24. The multi-view X-ray inspection portal of clause 16, wherein the given offset is between about 8 feet and about 6 feet.

Clause 25. The multi-view X-ray inspection portal of clause 16, wherein the given offset is about 7 feet.

Clause 26. A method of performing multi-view X-ray inspection, the method comprising:
a. permitting travel of a target object in a travel direction;
b. irradiating the target object, in a course of the travel, by first and second X-ray beams that are simultaneously active and incident at the target object at respective positions that are offset from each other parallel to the travel direction; and
c. irradiating the target object, in the course of the travel, by a third X-ray beam that is interleaved temporally with the first and second X-ray beams and incident at the target object at a respective position between the respective positions at which the first and second X-ray beams are incident.

Clause 27. The method of clause 26, further including elements of any of clauses 1-25 or performed consistent with elements of any of clauses 1-25.

Clause 28. A multi-view X-ray inspection system, comprising:
a. at least three X-ray beam-forming modules, each including an X-ray chopper wheel configured to rotate and to output a respective scanning X-ray pencil beam to irradiate a target object for X-ray inspection,
b. wherein at least one first X-ray beam-forming module is configured to have its X-ray chopper wheel rotate at a first rotational speed and define therein only a single beam aperture configured to output the respective scanning X-ray pencil beam per rotation,
c. and wherein at least one second X-ray beam-forming module is configured to have its X-ray chopper wheel rotate at a second rotational speed and to define therein two beam apertures configured to output the respective scanning X-ray pencil beam per rotation, the first rotational speed being twice the second rotational speed.

Clause 29. The multi-view X-ray inspection system of clause 28, further comprising:
a. a set of scatter detectors positioned proximally to at least one of the X-ray beam-forming modules such that the set of scatter detectors can detect X-rays scattered from the target object resulting from the at least one of the X-ray beam-forming modules irradiating the target object; and
b. an image generator configured to generate at least one scatter image based on an output signal of the set of scatter detectors.

Clause 30. The multi-view X-ray inspection system of clause 28 or clause 29, further including elements of any of clauses 1-25.

Clause 31. A method of performing multi-view X-ray inspection, the method comprising:
a. causing at least three X-ray chopper wheels to rotate and to irradiate a target object by respective scanning X-ray pencil beams output from respective X-ray chopper wheels;
b. causing at least one first of the X-ray chopper wheels to rotate at a first rotational speed and to output its respective scanning X-ray pencil beam through only a single aperture per rotation; and
c. causing at least one second of the X-ray chopper wheels to rotate at a second rotational speed and to output its respective X-ray pencil beam through two apertures per rotation, the first rotational speed being twice the second rotational speed.

Clause 32. The method of clause 31, further including elements of, or performing the method consistent with, any of clauses 1-25 or clause 29.

Clause 33. A multi-view X-ray inspection system, comprising:
a. three or more X-ray sources each with a rotating collimator assembly configured to output a scanning pencil beam of X-rays that illuminate one or more target objects, wherein at least two of the X-ray beams are simultaneously active and interleaved temporally with at least one of the other X-ray beams;
b. the rotational speed of each rotating collimator assembly being substantially equal;
c. wherein at least one of the rotating collimator assemblies defines two beam apertures that are illuminated per collimator rotation;
d. one or more scatter detectors positioned proximally to at least one of the X-ray sources to detect X-rays scattered from the source by the one or more target objects;
e. one or more controllers configured to display at least one scatter image from the output signals of the one or more scatter detectors.

Clause 34. The multi-view X-ray inspection system of clause 33, further including elements of any of clauses 1-25.

Clause 35. A multi-view X-ray inspection system, comprising:
a. three or more X-ray sources each with a rotating collimator assembly configured to output a scanning beam of X-rays that illuminate one or more target objects, wherein at least two of the X-ray beams are simultaneously active and interleaved temporally with at least one of the other X-ray beams;
b. the rotational speed of at least one of the rotating collimator assemblies being twice the rotational speed of another rotating collimator assembly;
c. wherein at least one collimator assembly rotating at the lower speed defines two beam apertures that are sequentially illuminated per collimator rotation, and at least one collimator assembly rotating at the higher speed defines only one beam aperture that is illuminated per collimator rotation;
d. one or more scatter detectors positioned proximally to at least one of the X-ray sources to detect X-rays scattered from the source by the one or more target objects;
e. one or more controllers configured to display at least one scatter image from the output signals of the one or more scatter detectors.

Clause 36. The multi-view X-ray inspection system of clause 35, further including elements of any of clauses 1-25.

### CONCLUDING CONSIDERATIONS

The embodiments of the invention described above are intended to be merely exemplary; numerous variations and modifications will be apparent to those skilled in the art. All such variations and modifications are intended to be within the scope of the present invention as defined in any appended claims.

What is claimed is:

1. A multi-view X-ray inspection portal, comprising:
a portal structure configured to permit a travel of a target object in a travel direction there through;
first, second, and third X-ray source modules mounted at the portal structure with respective offsets, between respective X-ray source modules, parallel to the travel direction, wherein the first, second, and third X-ray sources are configured to output first, second, and third X-ray beams, respectively, to irradiate the target object in a course of the travel; and
a set of scatter detectors disposed to receive scattered X-rays that are scattered from the target object upon a given X-ray beam irradiating the target object, the given X-ray beam selected from the first, second, and third X-ray beams,
wherein, the third X-ray source module is disposed between the first and second X-ray source modules parallel to the travel direction, and
wherein the first, second, and third X-ray source modules are configured such that the first and second X-ray beams can be simultaneously active and interleaved temporally with the third X-ray beam.

2. The multi-view X-ray inspection portal of claim 1, wherein a set of the X-ray beams selected from the group consisting of the first, second, and third X-ray beams and combinations thereof are fan beams.

3. The multi-view X-ray inspection portal of claim 1, wherein a set of the X-ray beams selected from the group consisting of the first, second, and third X-ray beams and combinations thereof are scanning pencil beams.

4. The multi-view X-ray inspection portal of claim 3, wherein a set of the X-ray source modules are X-ray beam forming modules including chopper wheels selected from the group consisting of rotating disk chopper wheels, rotating wheel chopper wheels, rotating hoop chopper wheels, rotating drum chopper wheels, and combinations thereof.

5. The multi-view X-ray inspection portal of claim 4, in which the X-ray beam-forming modules are configured to have respective beam sweep angles that are equal to each other.

6. The multi-view X-ray inspection portal of claim 4, in which the X-ray beam-forming modules are configured to have respective beam sweep angles that are unequal to each other.

7. The multi-view X-ray inspection portal of claim 4, in which all of the chopper wheels are configured to rotate at substantially equal angular speed.

8. The multi-view X-ray inspection portal of claim 4, in which a first set of the chopper wheels is configured to rotate at about twice the angular speed of a second set of the chopper wheels.

9. The multi-view X-ray inspection portal of claim 8, in which the second set of chopper wheels define therein two beam apertures that output scanning pencil beams per rotation, and wherein the first set of chopper wheels define therein only one beam aperture that outputs a scanning pencil beam per rotation.

10. The multi-view X-ray inspection portal of claim 4, in which the chopper wheels create at least two scanning pencil beams per rotation.

11. The multi-view X-ray inspection portal of claim 1,
wherein the set of scatter detectors is a first set of scatter detectors,
the multi-view X-ray inspection portal further comprising second and third sets of scatter detectors,
the first, second, and third sets of scatter detectors disposed to receive scattered X-rays that are scattered from the target objection upon the first, second, and third scanning pencil beams of X-rays, respectively, irradiating the target object.

12. The multi-view X-ray inspection portal of claim 1,
further including a fourth X-ray source module mounted at the portal structure and configured to output a fourth X-ray beam to irradiate the target object in the course of the travel,
the second X-ray source module disposed between the third and fourth X-ray source module parallel to the travel direction, and
wherein the first, second, third, and fourth X-ray source modules are configured such that the third and fourth X-ray beams can be simultaneously active and interleaved temporally with the first and second X-ray beams.

13. The multi-view X-ray inspection portal of claim 1, further including an image generator configured to generate, from output signals of at least one of the first, second, and third sets of scatter detectors, at least one X-ray scatter image for display.

14. The multi-view X-ray inspection portal of claim 1, further including collimator vanes mounted on the set of scatter detectors.

15. The multi-view X-ray inspection portal of claim 1, in which the scatter detectors are rotated to reduce crosstalk interference between the simultaneously active X-ray beams.

16. The multi-view X-ray inspection portal of claim 1, wherein a given offset between first and second X-ray beams parallel to the travel direction is less than or equal to about 15 feet.

17. The multi-view X-ray inspection portal of claim 16, wherein the given offset is less than or equal to about 10 feet.

18. The multi-view X-ray inspection portal of claim 16, wherein the given offset is between about 15 feet and about 7 feet.

19. The multi-view X-ray inspection portal of claim 16, wherein the given offset is between about 10 feet and about 7 feet.

20. The multi-view X-ray inspection portal of claim 16, wherein the given offset is between about 15 feet and about 5 feet.

21. The multi-view X-ray inspection portal of claim 16, wherein the given offset is between about 10 feet and about 5 feet.

22. The multi-view X-ray inspection portal of claim 16, wherein the given offset is between about 20 feet and about 15 feet.

23. The multi-view X-ray inspection portal of claim 16, wherein the given offset is between about 9 feet and about 5 feet.

24. The multi-view X-ray inspection portal of claim 16, wherein the given offset is between about 8 feet and about 6 feet.

25. The multi-view X-ray inspection portal of claim 16, wherein the given offset is about 7 feet.

26. A method of performing multi-view X-ray inspection, the method comprising:
permitting travel of a target object in a travel direction;
irradiating the target object, in a course of the travel, by first and second X-ray beams that are simultaneously active and incident at the target object at respective positions that are offset from each other parallel to the travel direction; and
irradiating the target object, in the course of the travel, by a third X-ray beam that is interleaved temporally with the first and second X-ray beams and incident at the target object at a respective position between the respective positions at which the first and second X-ray beams are incident.

27. A multi-view X-ray inspection system, comprising:
at least three X-ray beam-forming modules, each including an X-ray chopper wheel configured to rotate and to output a respective scanning X-ray pencil beam to irradiate a target object for X-ray inspection,
wherein at least one first X-ray beam-forming module is configured to have its X-ray chopper wheel rotate at a first rotational speed and define therein only a single beam aperture configured to output the respective scanning X-ray pencil beam per rotation,
and wherein at least one second X-ray beam-forming module is configured to have its X-ray chopper wheel rotate at a second rotational speed and to define therein two beam apertures configured to output the respective scanning X-ray pencil beam per rotation, the first rotational speed being twice the second rotational speed.

28. The multi-view X-ray inspection system of claim 28, further comprising:
a set of scatter detectors positioned proximally to at least one of the X-ray beam-forming modules such that the set of scatter detectors can detect X-rays scattered from the target object resulting from the at least one of the X-ray beam-forming modules irradiating the target object; and
an image generator configured to generate at least one scatter image based on an output signal of the set of scatter detectors.

29. A method of performing multi-view X-ray inspection, the method comprising:
causing at least three X-ray chopper wheels to rotate and to irradiate a target object by respective scanning X-ray pencil beams output from respective X-ray chopper wheels;
causing at least one first of the X-ray chopper wheels to rotate at a first rotational speed and to output its respective scanning X-ray pencil beam through only a single aperture per rotation; and
causing at least one second of the X-ray chopper wheels to rotate at a second rotational speed and to output its respective X-ray pencil beam through two apertures per rotation, the first rotational speed being twice the second rotational speed.
